(19) United States
(12) Patent Application Publication
(10) Pub. No.: US 2006/0286918 A1
(43) Pub. Date: Dec. 21, 2006

(54) Self-powered automated air vent

(76) Inventor: George A. Vargas, Moorpark, CA (US)

Correspondence Address: KOPPEL, PATRICK & HEYBL, 555 ST. CHARLES DRIVE, SUITE 107, THOUSAND OAKS, CA, 91360, US

(21) Appl. No.: 11/300,702

(22) Filed: Dec. 14, 2005

Related U.S. Application Data
(60) Provisional application No. 60/691,624, filed on Jun. 16, 2005.

(51) Int. Cl. B60H 1/34

(52) U.S. Cl. 454/155

(57) ABSTRACT

A self-powered automated air vent comprises a frame suitable for mounting to a duct which carries forced air, a set of louvers within the frame which can be positioned between closed and open positions, and a motor which adjusts the louvers in response to a drive signal provided by a vent-mounted control circuit. The control circuit is preferably arranged to wirelessly receive one or more control signals, and to provide the drive signal in response. An airflow-driven generator positioned within the duct produces an output current when sufficiently driven by forced air. An energy storage device receives and stores the output current, which is used to power the vent-mounted control circuit and louver motor. A wireless central controller is preferably employed to transmit the control signals to each vent's control circuit; a preferred wireless central controller interfaces with and is programmed by a personal computer.

### RELATED APPLICATIONS

This application claims the benefit of provisional patent application No. 60/691,624 to Vargas, filed Jun. 16, 2005.

### BACKGROUND OF THE INVENTION

1. Field of the Invention

This invention relates to heating, ventilation and air conditioning (HVAC) systems, and particularly to air vents for such systems which are capable of being automatically adjusted.

2. Description of the Related Art

The use of forced air heating and air conditioning in residential and commercial buildings is commonplace. Air which has been heated or cooled is forced through ducts, and discharged into one or more rooms via air vents mounted onto the ducts. In a basic system, a heating and/or cooling unit is turned on and off with a thermostat as needed to maintain a desired temperature, and each air vent consists of a set of louvers which can be manually opened or closed as desired.

More sophisticated HVAC systems employ controllable air vents. Conventionally, such vents include some electrical or electromechanical means by which its louvers can be adjusted. The adjustment means for each vent is hardwired to a remote control unit, which is typically arranged to convey control information and power to a local controller at each vent via the wiring.

A number of approaches have been devised to eliminate the need to provide wiring to each air vent. For example, in U.S. Pat. No. 5,364,304 to Hampton, a thermostat communicates wirelessly to a vent, which includes a turbine-operated generator in the air discharge path. Air flowing through the generator creates an electrical current, which is stored and used locally to operate the vent's control unit. In addition to generating power, the turbine-operated generator is used to control the air flow. In response to a control signal from the thermostat, the loading on the generator is increased or decreased, which has the effect of increasing or decreasing the flow rate for air discharged from the vent.

Another approach is described in U.S. Pat. No. 5,251,815 to Foye, in which air flow is used to spin a turbine-operated generator. The resulting power operates a control circuit, which also receives a fixed set point representative of a desired air flow volume. The control circuit operates to cause a damper to be adjusted as needed to achieve the desired air flow volume.

### SUMMARY OF THE INVENTION

A self-powered automated air vent is presented. The vent enables separate temperature control to be provided for each room in a HVAC system, and requires no wiring.

The present air vent comprises a frame suitable for mounting to a duct which carries forced air, and a set of louvers within the frame through which forced air to be expelled through the vent passes. The louvers can be positioned between closed and open positions using a motor coupled to the louvers, which is arranged to open or close the louvers in response to a drive signal. The air vent includes a vent-mounted control circuit which provides the motor drive signal. Though the control circuit can be configured to operate the motor autonomously, the control circuit is preferably arranged to wirelessly receive one or more control signals, and to provide the drive signal in response.

The air vent is self-powered. An airflow-driven generator such as an air vane generator is positioned within the duct, and produces an output current when sufficiently driven by forced air. An energy storage device such as a battery or capacitor receives and stores the output current. The stored current is used to power the vent-mounted control circuit, and thereby the louver motor.

With the air vent being self-powered and receiving control signals wirelessly, it is easy to install—especially if replacing an existing air vent—and requires no wiring. Use of multiple vents enables separate temperature control for each room.

A wireless central controller is preferably employed to transmit the control signals to each vent's control circuit. For example, one type of wireless central controller includes an interface suitable for connection to a personal computer (PC), with the controller and PC arranged such that the controller can be programmed by the PC to operate the vent in a desired manner. Other wireless devices can be provided which can be configured to communicate directly with a vent's control circuit or, preferably, with the wireless central controller, to effect changes in one or more air vents. For example, a wireless remote unit can be provided for use in a room within which a vent is located. The remote unit preferably includes a temperature sensor and is arranged to transmit temperature data to the wireless central controller as necessary to maintain the sensed temperature at a predetermined level. The remote unit might also include a motion sensor and be arranged to transmit data to the wireless central controller as necessary to operate the vent in a desired manner when motion is sensed. The remote unit could also include a user interface by which a user could program the vent to operate in a desired manner.

Another type of wireless device might take the form of a device for replacing an existing thermostat, which includes circuitry to produce the control signals needed to operate the heating, cooling, and/or fan components of a forced air system—preferably in response to commands received from a wireless central controller.

Further features and advantages of the invention will be apparent to those skilled in the art from the following detailed description, taken together with the accompanying drawings.

### BRIEF DESCRIPTION OF THE DRAWINGS

FIG. 1 is block diagram of a self-powered automated air vent in accordance with the present invention.

FIG. 2 is a block diagram illustrating the principles of a wireless central controller as might be used with an air vent per the present invention.

FIG. 3 is a schematic diagram illustrating the principles of an energy storage system as might be used with an air vent per the present invention.

FIG. 4 is a block diagram illustrating the principles of a wireless remote unit as might be used with an air vent per the present invention.

FIG. 5 is a block diagram illustrating the principles of a thermostat replacement unit as might be used with an air vent per the present invention.

### DETAILED DESCRIPTION OF THE INVENTION

The present invention is a self-powered, automated air vent, which enables separate temperature control for each room in which such a vent it is installed. The vent is self-powered and is controlled wirelessly; as such, it requires no wiring and no separate power source, making it easy to install—especially if replacing an existing air vent.

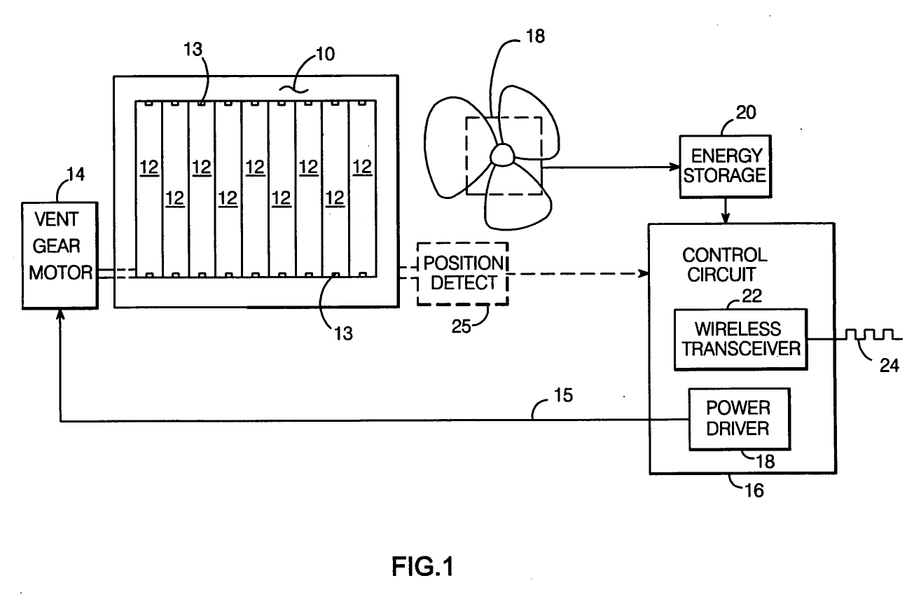

A block diagram of a self-powered automated air vent in accordance with the present invention is shown in FIG. 1. The air vent includes a frame 10 suitable for mounting to a duct which carries air circulated by a forced air heating and/or air conditioning system. A set of louvers 12 is mounted within frame 10, through which forced air to be expelled via the vent passes. Louvers 12 are adjustable—i.e., they can be positioned such that the air vent is fully closed or fully open. Typically, the louvers comprise thin slats which are attached between pivot points on opposite sides of frame 10, with the slats linked together so that they pivot open or closed in unison.

A motor 14, typically a gear motor, is coupled to louvers 12, and arranged to open or close the louvers in response to a drive signal 15, which is provided by a vent-mounted control circuit 16.

The air vent is self-powered; i.e., the power required to operate the motor and control circuit are provided by the air vent assembly itself. This is accomplished with the use of an airflow-driven generator 18, which is mounted on or near the vent. The generator provides an output current when sufficiently driven by forced air in the duct to which the vent is mounted. An energy storage device 20, such as a capacitor or battery, receives and stores the current produced by the generator, and the stored current is used to power control circuit 16, which in turn provides drive signal 15 to louver motor 14—via a power driver circuit 18, for example.

Vent-mounted control circuit 16 preferably includes a wireless transceiver 22 with which the control circuit can wirelessly receive one or more control signals (via an antenna 24). The control circuit is then arranged to provide drive signal 15 in response. Control signals transmitted to control circuit 16 would typically be intended to operate the vent as needed to obtain a desired room temperature.

Alternatively, a means could be provided on the vent itself, such as with buttons or a thumbwheel, by which a user could input a desired temperature. Temperature and air flow could be sensed locally, and control circuit 16 could be arranged to operate the louvers as needed to maintain the temperature within a temperature range.

An air vent per the present invention might also include a position detector 25, typically a potentiometer coupled to a louver pivot point, which reports the louver position to control circuit 16. This enables the control circuit to provide closed loop control of louver position, and/or to provide position data to a central control means.

With the present air vent being self-powered and receiving control signals wirelessly (or set to a desired temperature locally), no wiring need be routed to it. This makes the vent easy to install, as it simply needs to be physically mounted to a duct. This is particularly straightforward if the present vent is used to replace an existing vent. Vents in accordance with the present invention can be mounted in each room. Since each vent is individually controllable, the use of multiple vents enables separate temperature control for each room.

Control signals are preferably provided to each vent-mounted control circuit by a wireless central controller, which may be arranged to control multiple vents. The central wireless controller is preferably a small microprocessor-based device which can be plugged into a personal computer (PC), preferably via a USB port (though other connection means could also be used, such as a serial interface), and programmed by a user so that the vents are operated in a desired manner. Once programmed, a central wireless controller is preferably arranged so that it may be operated independently from the PC, with the controller's programming maintained in non-volatile memory.

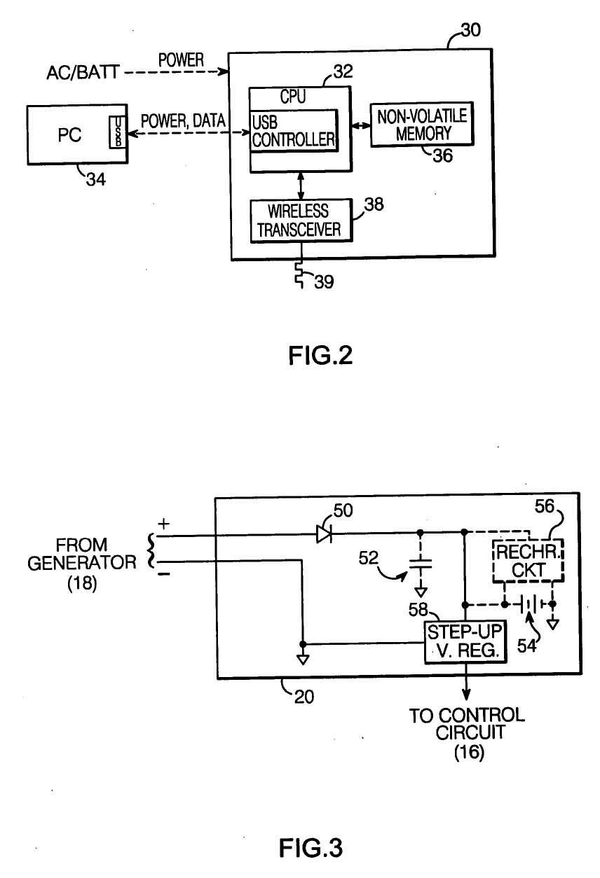

A block diagram illustrating the principles of a wireless central controller 30 in accordance with the present invention is shown in FIG. 2. Controller 30 preferably includes a CPU and USB controller 32, with which the controller interfaces with a PC 34. A non-volatile memory 36 is provided for use by the CPU, and a wireless transceiver 38 and antenna 39 is provided to transmit control signals to vent-mounted control circuits as described above, and to receive data from various wireless devices as described below. Wireless central controller 30 is preferably arranged to be powered via the USB connection when interfaced to a PC, or by a wall plug or a battery pack when operated independently of a PC.

Wireless central controller 30 is preferably arranged to receive temperature data from one or more rooms, and to transmit control signals to one or more vent-mounted control circuits to operate their respective vents such that their louvers are opened or closed as necessary to achieve a desired temperature. Controller 30 is preferably arranged so that each room can have a different desired temperature, and each vent can be independently operated as needed to maintain the different temperatures.

Wireless central controller 30 operates in accordance with a software program. The software can be configured to operate controller 30 is many different ways; one list of functions for controller 30 might include:

1) Enabling each room to be named.

2) Enabling a temperature range to be specified for each room.

3) Enabling a temperature sensor to be assigned to each room (discussed below).

4) Enabling a motion sensor to be assigned to each room.

5) Enabling a room to be monitored, for example, all the time, during a selected time of the day, never, or when movement is detected and then for specified delay after that.

6) Enabling a vent to be assigned to a room. Several vents could be controlled by the same temperature and/or motion sensors if desired.

7) Enabling the precise vent louver position to be specified, in terms of percentage, for example, when the vent is opened.

When interfaced to a PC, controller 30 is preferably arranged to display status information for a room, such as its temperature, the voltage available from a vent's energy storage device, or detected motion. When status information is to be conveyed from an air vent to controller 30, each vent-mounted control circuit must also include a wireless transmitter.

A block diagram illustrating the principles of a basic energy storage device 20 is shown in FIG. 3. Current from airflow-driven generator 18 received by energy storage device 20 is rectified by a diode 50, which also block stored energy from powering the generator. The rectified current is used to charge a capacitor 52, and/or to charge a rechargeable battery 54. A recharging circuit 56 would typically be used to manage the battery recharging. A step-up voltage regulator 58 might be used to provide the voltage required for the proper operation of vent-mounted control circuit 16. Each vent-mounted control circuit is preferably arranged to enter a low power “sleep mode” when the position of the vent's louvers is static. Status information is preferably provided to wireless central controller 30 upon periodic waking, at which time any pending commands are received and processed.

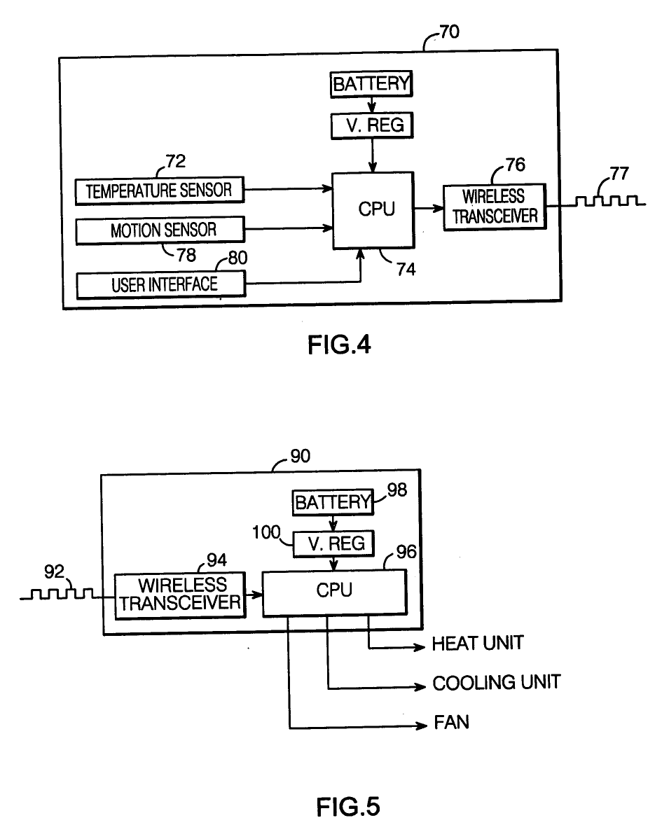

The present system might also include at least one wireless remote unit, which would typically reside in the room in which an air vent is mounted. A block diagram illustrating the principles of a wireless remote unit 70 is shown in FIG. 4. The unit preferably includes a temperature sensor 72, the output of which is provided to a processor 74 which is arranged to transmit the sensed temperature via a wireless transceiver 76 and an antenna 77 to wireless central controller 30. Controller 30 is preferably arranged to respond by transmitting control signals as necessary to one or more air vents to maintain the temperature sensed by sensor 72 at a predetermined level.

Wireless remote unit 70 might also include a motion sensor 78, the output of which is provided to processor 74 and then transmitted to wireless central controller 30. Controller 30 is preferably arranged to respond by transmitting control signals as necessary to one or more air vents to operate the vents in a desired manner when motion is sensed. For example, controller 30 might be arranged to open the vent louvers in all rooms in which motion is sensed.

Wireless remote unit 70 can also include a user interface 80 by which a user can enter data specifying the manner in which a vent is to operate. For example, buttons or a key pad might be provided on the unit with which a user could enter a desired temperature value, or reset the desired temperature to a desired temperature range. The output of user interface 80 is provided to processor 74 and transmitted to wireless central controller 30, which is arranged to transmit control signals as necessary to one or more air vents to achieve the desired manner of operation.

Another possible element of a system which includes the present self-powered automated air vent is a unit intended to provide the functions of a conventional thermostat; i.e., that of operating the heating, cooling and/or fan units commonly found in a HVAC system. An example of such a thermostat replacement unit 90 is shown in FIG. 5. Unit 90 receives commands from wireless central controller 30 via an antenna 92 and a wireless transceiver 94. The received commands are provided to a processor 96, which would typically be powered by a battery (98) and voltage regulator (100), though other means, such as a transformer or an AC-powered DC power supply, might also be used. Processor 96 is arranged to respond to the received commands by operating the heating, cooling, and/or fan units as required.

Wireless technology is preferably used to provide bidirectional communication between the devices described above. Although the system described herein employs a wireless central controller to receive data from the various devices and make control decisions for each air vent, an alternative configuration would enable other system devices to make such decisions. For example, a system could be configured in which a wireless remote unit communicates directly with and thereby control one or more air vents.

The present air vent is preferably compact and self-contained, with airflow-driven generator 18 preferably mounted directly to the vent frame with the air vanes positioned behind the louvers. The vent is preferably arranged such that the louvers are open when there is no air flow. Then, the air vanes will begin spinning as soon as air begins to flow, thereby allowing the vent to power up quickly. The vent is preferably arranged so that is may be quickly charged, and remains charged for several days with no air flow. To conserve power, the louvers are preferably only adjusted when air is flowing. The airflow-driven generator could alternatively be mounted in a duct, separate from the vent frame, and connected to the control circuit via wires.

Note that the type and implementations of the various wireless devices described herein are merely exemplary; systems employing an air vent in accordance with the present invention could include a wide variety of device types, each with many possible implementations. It is only required that an air vent per the present invention include: a frame suitable for mounting to a forced air duct; a set of louvers within the frame which are operable between closed and open positions; a motor coupled to the louvers and arranged to open or close the louvers in response to a drive signal; a vent-mounted control circuit which provides the drive signal; an airflow-driven generator arranged to provide an output current when sufficiently driven by forced air in the duct; and an energy storage device which receives and stores the output current, which powers the control circuit and louver motor. In a preferred embodiment, the vent-mounted control circuit is arranged to wirelessly receive one or more control signals and to provide the motor drive signal in response.

Also note that, though the wireless devices described herein are shown as using wireless transceivers, some devices may only require a wireless transmitter or a wireless receiver. However, wireless transceivers are preferred, as they enable bidirectional communication which allows each device to be controlled as well as to provide status.

While particular embodiments of the invention have been shown and described, numerous variations and alternate embodiments will occur to those skilled in the art. Accordingly, it is intended that the invention be limited only in terms of the appended claims.

I claim:

1. An air vent, comprising:
a frame suitable for mounting to a duct which carries forced air;
a set of louvers within said frame through which forced air to be expelled via said vent passes, said louvers operable between a closed position which blocks forced air from being expelled and an open position which permits forced air to be expelled;
a motor coupled to said louvers and arranged to open or close said louvers in response to a drive signal;
a vent-mounted control circuit which provides said drive signal;
an airflow-driven generator positioned within said duct, said generator arranged to provide an output current when sufficiently driven by said forced air; and
an energy storage device which receives and stores said output current, said vent-mounted control circuit and said energy storage device arranged such that said energy storage device powers said control circuit and thereby said louver motor.

2. The air vent of claim 1, wherein said energy storage device is a battery.

3. The air vent of claim 2, wherein said battery is a rechargeable battery, said energy storage device further comprising a recharging circuit arranged to provide a charge current suitable for recharging said battery.

4. The air vent of claim 1, wherein said energy storage device is a capacitor.

5. The air vent of claim 1, wherein said airflow-driven generator is an air vane generator.

6. The air vent of claim 1, wherein said vent-mounted control circuit is further arranged to wirelessly receive one or more control signals and to provide said drive signal in response.

7. The air vent of claim 6, further comprising a wireless central controller which transmits at least one of said wireless control signals.

8. The air vent of claim 7, wherein said wireless central controller includes an interface suitable for connection to a personal computer, said wireless central controller and personal computer arranged such that said wireless central controller can be programmed by said computer to operate said air vent in a desired manner.

9. The air vent of claim 8, wherein said wireless central controller is further arranged to maintain said programming when not interfaced to said personal computer.

10. The air vent of claim 7, further comprising a wireless remote unit which includes a temperature sensor and is arranged to transmit said sensed temperature to said wireless central controller, said wireless central controller arranged to transmit said control signals as necessary to maintain the temperature sensed by said sensor at a predetermined level.

11. The air vent of claim 7, further comprising a wireless remote unit which includes a motion sensor and is arranged to transmit data indicating that motion has been sensed to said wireless central controller, said wireless central controller arranged to transmit said control signals as necessary to operate said air vent in a desired manner when motion is sensed.

12. The air vent of claim 7, further comprising a wireless remote unit which includes a user interface by which a user can enter data specifying the manner in which said vent is to operate, said wireless remote unit arranged to transmit said data to said wireless central controller, said wireless central controller arranged to transmit said control signals as necessary to operate said air vent in said specified manner.

13. The air vent of claim 12, wherein said data is a desired temperature.

14. The air vent of claim 7, further comprising a thermostat replacement unit which receives commands from said wireless central controller and includes circuitry that produces control signals suitable for operating the heating, cooling, and/or fan components of a forced air system in response to said commands.

15. The air vent of claim 7, wherein said wireless central controller is programmed to operate said air vent in accordance with a predetermined time schedule.

16. The air vent of claim 7, wherein said wireless central controller is arranged to provide control signals to multiple ones of said air vents such that each of said vents can be individually controlled.

17. The air vent of claim 1, further comprising a position detector arranged to provide an output which varies with the position of said louvers, said vent-mounted control circuit arranged to receive said position detector output and to provide said drive signal such that said louvers achieve a desired position.

18. The air vent of claim 1, wherein said vent-mounted control circuit is arranged to enter a low power sleep mode when the position of said louvers is static.

19. The air vent of claim 1, wherein said airflow-driven generator is mounted to said air vent frame.

20. The air vent of claim 1, wherein said airflow-driven generator is mounted in said duct and separate from said air vent frame.

21. A heating, ventilation and air conditioning (HVAC) system comprising one or more self-powered automated air vents,
each of said air vents comprising:
a frame suitable for mounting to a duct which carries forced air;
a set of louvers within said frame through which air to be expelled via said vent passes, said louvers operable between a closed position which blocks forced air from being expelled and an open position which permits forced air to be expelled;
a motor coupled to said louvers and arranged to open or close said louvers in response to a drive signal;
a vent-mounted control circuit which provides said drive signal;
an airflow-driven generator positioned within said duct, said generator arranged to provide an output current when sufficiently driven by said forced air; and
an energy storage device which receives and stores said output current, said vent-mounted control circuit and said energy storage device arranged such that said energy storage device powers said control circuit and thereby said louver motor, said vent-mounted control circuit arranged to wirelessly receive one or more control signals and to provide said drive signal in response; and
a wireless central controller arranged to transmit said wireless control signals to each of said air vents.

22. The air vent of claim 21, wherein said wireless central controller includes an interface suitable for connection to a personal computer, said wireless central controller and personal computer arranged such that said wireless central controller can be programmed by said computer to operate said air vent in a desired manner.

23. The air vent of claim 22, further comprising one or more wireless remote units, each of which comprises:
a temperature sensor, said remote unit arranged to transmit said sensed temperature to said wireless central controller;
a motion sensor, said remote unit arranged to transmit data indicating that motion has been sensed to said wireless central controller; and
a user interface by which a user can enter data specifying the manner in which said vent is to operate, said wireless remote unit arranged to transmit said user-entered data to said wireless central controller;
said wireless central controller arranged to:
transmit said control signals as necessary to one or more air vents to maintain the temperature sensed by said temperature sensor at a predetermined level,
transmit said control signals as necessary to one or more air vents to operate said air vents in a desired manner when motion is sensed, and
transmit said control signals as necessary to one or more air vents to operate said air vents in said specified manner.
